(19) United States
(12) Patent Application Publication
(10) Pub. No.: US 2008/0161020 A1
(43) Pub. Date: Jul. 3, 2008

(54) Methods and Devices for Sharing Location Information in a Calendar

(75) Inventor: Mark R. Malon, Wauconda, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/617,641

(22) Filed: Dec. 28, 2006

(51) Int. Cl. H04Q 7/20

(52) U.S. Cl. 455/456.6

(57) ABSTRACT

Disclosed are a device and a method of an AGPS enabled mobile first communication device having a memory with a calendar or other type of organizer. The method may include saving a waypoint in memory, the waypoint having coordinates ascertained according to an AGPS capability of the first communication device, to form waypoint information. The method may include associating the waypoint information with an entry in the calendar in the memory. The method may further include enabling sharing with a second communication device, the entry in the calendar with the waypoint information. In another embodiment a method may include sending a message to request waypoint information and time data from a calendar to an AGPS enabled mobile communication device. The AGPS enabled mobile communication device may allow sharing of waypoint information and time data from a shared portion of the calendar to form retrieved calendar data.

### FIELD

Described are methods and devices for sharing location information, and more particularly methods and devices for sharing location information stored in conjunction with a calendar of a mobile communication device.

### BACKGROUND

Manufacturers of mobile communication devices are increasingly adding functionality to their devices. Mobile communication devices may include several transceivers in addition to a cellular transceiver. For example, a mobile communication device may be GPS enabled, Bluetooth and/or WIFI enabled. Moreover, mobile communication devices may include email functionality, Internet browsers, and organizers. Bluetooth enabled cellular telephones may be PC compatible so that a user may upload data such as a calendar from a PC or other source to the mobile communication device. Likewise, files generated or captured on the mobile communication device may be downloaded to a PC. With their expanded functionality and their ability for interactive communication with other devices, cellular telephones in particular are becoming more than simply mobile communication devices. They are evolving into powerful tools for information management.

Users of mobile communication devices may travel to different locations on a regular basis, and/or may have irregular travel to different locations. In this way it may be difficult for a delivery service or other type of entity to determine the whereabouts for example of a delivery recipient since a recipient may be mobile. A user's planned schedule of appointments including locations may be stored in an organizer and/or a calendar on the mobile communication device or other device. However, unless a specific message is sent manually to a delivery service to indicate the whereabouts of a recipient, for example according to AGPS coordinates, there may be no way for a delivery service to re-route a delivery so that it may be delivered to a location of a mobile recipient.

### BRIEF DESCRIPTION OF THE DRAWINGS

FIG. 1 depicts a mobile communication device that may be configured for communication with an AGPS server.

FIG. 2 depicts a mobile communication device that may be configured to communicate with an AGPS server via communication link to update a calendar with waypoints to form a waypoint calendar;

FIG. 3 is a flowchart illustrating an embodiment of a method for saving a waypoint in memory, the waypoint having coordinates ascertained according to an AGPS capability of the first communication device, to form waypoint information; and

FIG. 4 is a signal flow diagram combined with a flowchart to illustrate interaction in a system of a mobile communication device and a second device that may or may not be mobile.

### DETAILED DESCRIPTION

With an address or intersection, coordinates of a user's locations may be determined in conjunction with the user's Assisted Global Positioning System (AGPS) enabled device. Moreover, a user may determine his or her coordinates in real time in conjunction with the user's AGPS enabled device. It may be beneficial if a user was able to integrate either or both planned and unplanned AGPS coordinates with his or her calendar. Moreover, it may be beneficial if there were a manner in which a delivery service or other type of entity could access the coordinate information without the necessity of a mobile user manually sending a message including coordinates to the delivery service. If a delivery service were able to access coordinate information of a user in conjunction with the user's calendar or other type of organizer, it may be less difficult for a delivery service to determine the whereabouts of a delivery recipient who may be mobile.

Disclosed are a device and a method of an AGPS enabled mobile first communication device having a memory with a calendar or other type of organizer. The method may include saving a waypoint in memory, the waypoint having coordinates ascertained according to an AGPS capability of the first communication device, to form waypoint information. The method may include associating the waypoint information with an entry in the calendar in the memory. The method may further include enabling sharing with a second communication device, the entry in the calendar with the waypoint information.

Disclosed is another embodiment of a method that may include sending a message to request waypoint information and time data from a calendar to an AGPS enabled mobile communication device. The AGPS enabled mobile communication device may allow sharing of waypoint information and time data from a shared portion of the calendar to form retrieved calendar data.

Disclosed is yet another embodiment of a method of a system comprising an AGPS enabled mobile first communication device and a second communication device. The method may include the first communication device saving a waypoint in memory, the waypoint having coordinates ascertained according to an AGPS capability of the first communication device, to form waypoint information. The first communication device may associate waypoint information with an entry in a calendar stored in memory of the first communication device and the first communication device may enable sharing with the second communication device, the entry in the calendar with the waypoint information.

A disclosed mobile communication device may include a controller configured to execute instructions of instruction modules, a memory coupled to the controller, the memory configured to store instruction modules and to store calendar data including calendar entries. The disclosed mobile communication device may further include an AGPS module configured to ascertain coordinates of a waypoint and configured to form waypoint information and a calendar module with instructions to share stored calendar entries including stored waypoint information. An access enablement module may be included with instructions to allow or deny access by a second communication device to at least one stored calendar entry. Accordingly, a delivery service or other type of entity may be able to access coordinate information of a user in conjunction with the user's calendar or other type of organizer to determine the whereabouts of a delivery recipient that may be mobile.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

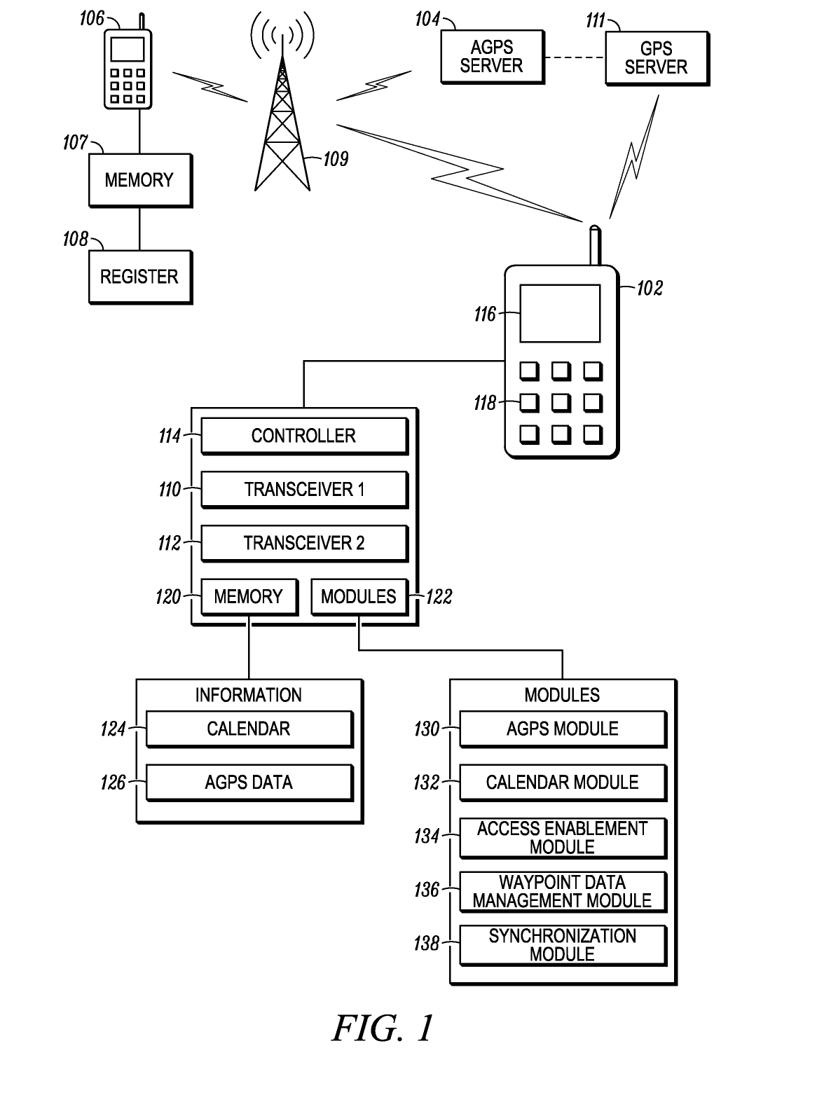

FIG. 1 depicts a mobile communication device 102 that may be configured for communication with a GPS or AGPS server 104. The mobile communication device 102 may also be in communication with a second communication device 106 that may or may not be a mobile communication device. The second device 106 may include a memory 107 that may store information for example in a register 108.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The AGPS server 104 is depicted as a remote server within a wireless communication network 109. The AGPS server 104 may be part of any network 109. A network of course may be any type of wireless network including an ad hoc or wireless personal area network, a WiFi or wireless local area network, and a cellular or wireless wide area network. Likewise, the AGPS server 104 may be of any suitable configuration. The AGPS server 104 may be implemented as a single server or as a plurality of servers in communication in any arrangement. The operations of the server 104 may be distributed among different servers or devices that may communicate in any manner. It is understood that the depiction in FIG. 1 is for illustrative purposes.

AGPS technology may use an AGPS server, also referred to as an assistance server 104 to reduce the time required to determine a location using Global Positioning System (GPS) technology. In AGPS networks, the mobile communication device 102 that may have a limited processing power and may be under less than ideal locations for position fixing, may communicate with the assistance server 104 that has high processing power and access to a reference network. The assistance server 104 may have the ability to access information from a reference network and also may have computing power greater than that of mobile communication device 102. Mobile communication device 102 may further include a GPS transceiver 110 and may also communicate with a GPS server 111. In an AGPS system, the assistance server 104 may communicate with a GPS transceiver 110 of the mobile communication device 102 over a cellular network 109 wherein the mobile communication device 102 communicates with the cellular network 109 via a cellular transceiver 112.

FIG. 1 further illustrates that the mobile communication device 102 may include a controller 114, a display screen 116 and a user input device such as a keypad 118. The device can further include memory 120 and modules 122. The memory may store information such as a calendar 124 and received AGPS data 126. The modules may carry out certain processes of the methods as described herein. The modules may be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The modules 122 may include, for example, an AGPS module 130 that may be configured to ascertain coordinates of a waypoint and may be configured to form waypoint information, a calendar module 132 that may be configured to share stored calendar entries including stored waypoint information and an access enablement module 134 that may be configured to allow or deny access by a second communication device to at least one stored calendar entry. The modules 122 may further include a waypoint data management module 136 configured to associate a radius with particular waypoint information and a synchronization module 138 configured to provide updated calendar entries to a second mobile communication device. The operations in accordance with the modules will be discussed in more detail below.

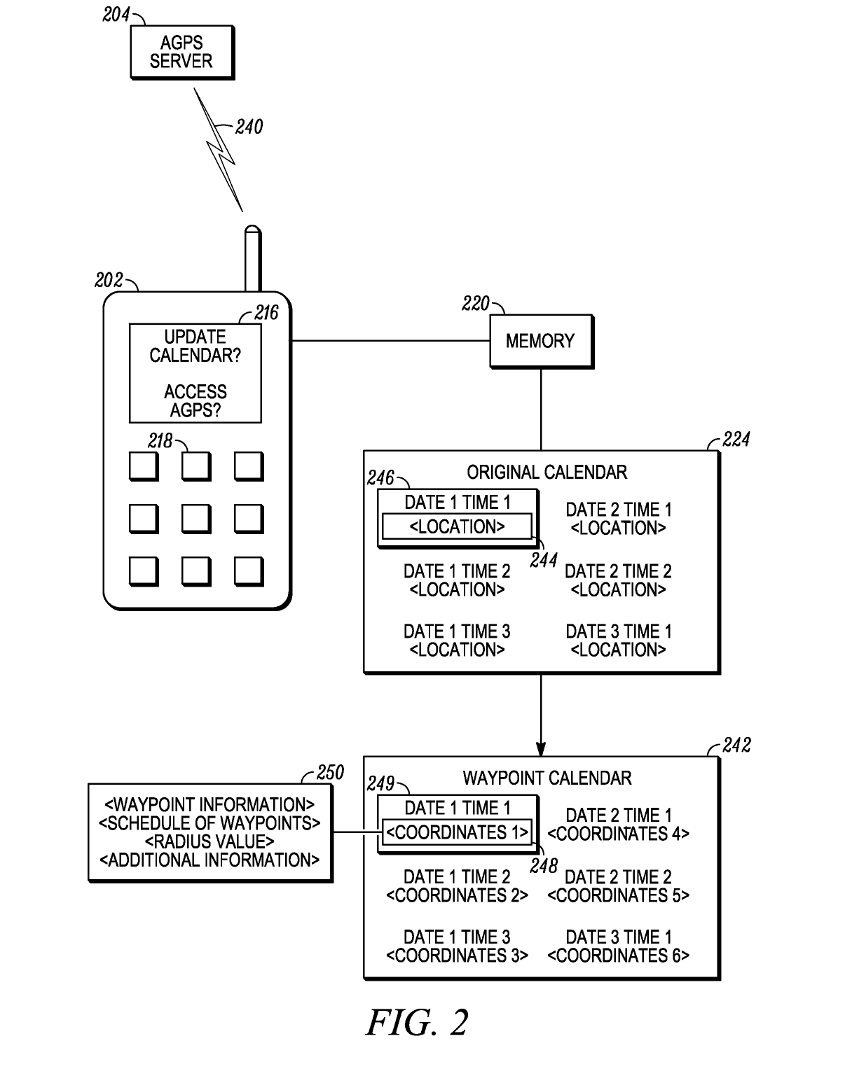

FIG. 2 depicts a mobile communication device 202 that may be configured to communicate with an AGPS server 204 via communication link 240 to populate and/or update a calendar 224 with one or more waypoints to form a waypoint calendar 242. A calendar 224 may include standard information such as a contact and for example a date and a time of a meeting so that a schedule may be formed. A data field may be annexed to a calendar entry for location information 244. The mobile communication device 202 in accordance with an AGPS module 130 (see FIG. 1) may be able to ascertain waypoint coordinates to update calendar data 224 and populate one or more fields, such as location field 244, of at least one calendar entry 246 so that it may include waypoint information such as location coordinates to form a waypoint calendar 242. A calendar module 132 may include instructions to share stored calendar entries including waypoint information included with at least one calendar entry 249 of a waypoint calendar 242.

A field 244 for waypoint information of the original calendar 224 may be populated either in advance of a user arriving at a particular location, or simultaneously with the user's arrival at a particular location. In one embodiment, a user may instruct the device 202 to initiate communication 240 with APGS server 204 to acquire waypoint information for the location field 244. In another embodiment, communication 240 may be automatic in accordance, for example, with user preferences and/or default preferences to acquire waypoint information for the location field 244.

The waypoint data management module 136 (see FIG. 1) may be configured to associate other information such as a radius with particular waypoint information 248. As discussed above, a location field 244 may be populated with coordinate information 248 for a location. As described above, the coordinates may be supplied by the AGPS server 204 and may be in a form characteristic of AGPS coordinates. It is understood that, any supplied coordinates that may be received from any source in any manner may be used to populate 248 of the location field 244 so that it includes coordinate information. It is further understood that any number of fields may be used for coordinate information. The coordinate information 250 of the populated field 248 may include for example, waypoint information, a schedule of waypoints, a waypoint radius value and/or additional information. In one embodiment, a waypoint radius may provide information related to the area in which a user may be located and a schedule of waypoints, for example, may refer to different waypoints within the radius.

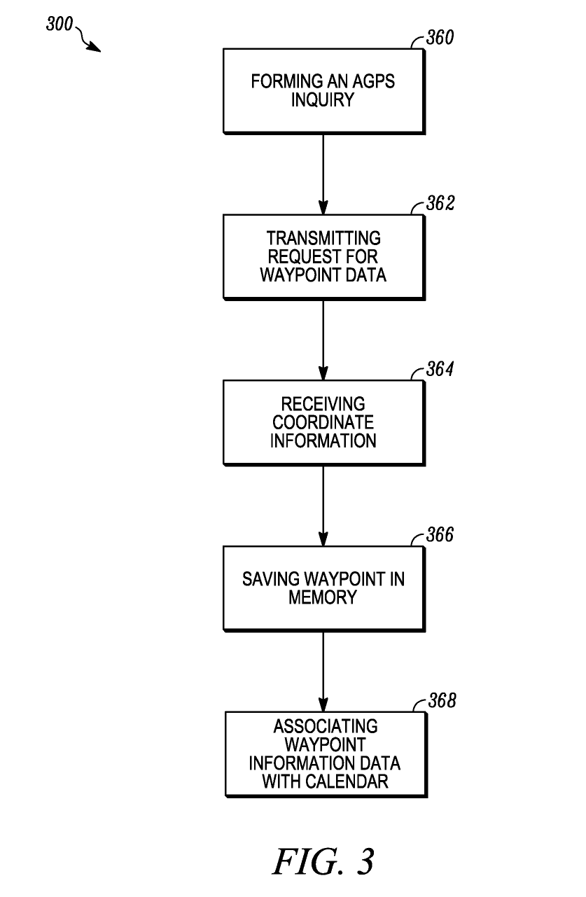

FIG. 3 is a flowchart illustrating an embodiment of a method 300 for saving a waypoint in memory, the waypoint having coordinates ascertained according to an AGPS capability of the first communication device 102 (see FIG. 1), to form waypoint information. A user may have planned a schedule of one or more locations where the user intends to be present. The schedule may be listed in a calendar 224 (see FIG. 2) on the mobile communication device 102. The schedule may be dependent on the mobility of the user. Different users may treat their schedules with more or less precision than others. Therefore, the entries into the calendar 224 (see FIG. 2) may be dependent upon the practices of the user or dependent upon other factors.

With an address or intersection, coordinates of a user's locations may be determined in conjunction with the capabilities of the (AGPS) enabled device 102 (see FIG. 1). A user may determine his or her coordinates in advance or in real time in conjunction with the user's AGPS enabled device. In this way the user may be able to integrate either or both planned and unplanned AGPS coordinates with his or her calendar. In one embodiment, a user may manually and/or the device 102 may automatically form an AGPS inquiry 360 in conjunction with information including an address, an intersection, or other location data. The device 102 may transmit a request for waypoint data 362 that may be received by the device 364. The data received in response to the AGPS inquiry may include a waypoint that may be saved in memory 366, the waypoint having coordinates ascertained according to an AGPS capability of the first communication device, to form waypoint information. Associating the waypoint information 368 with an entry in the calendar 224 in the memory 220 may include storing the waypoint information 248 in a data field annexed to a calendar entry 249 (see FIG. 2).

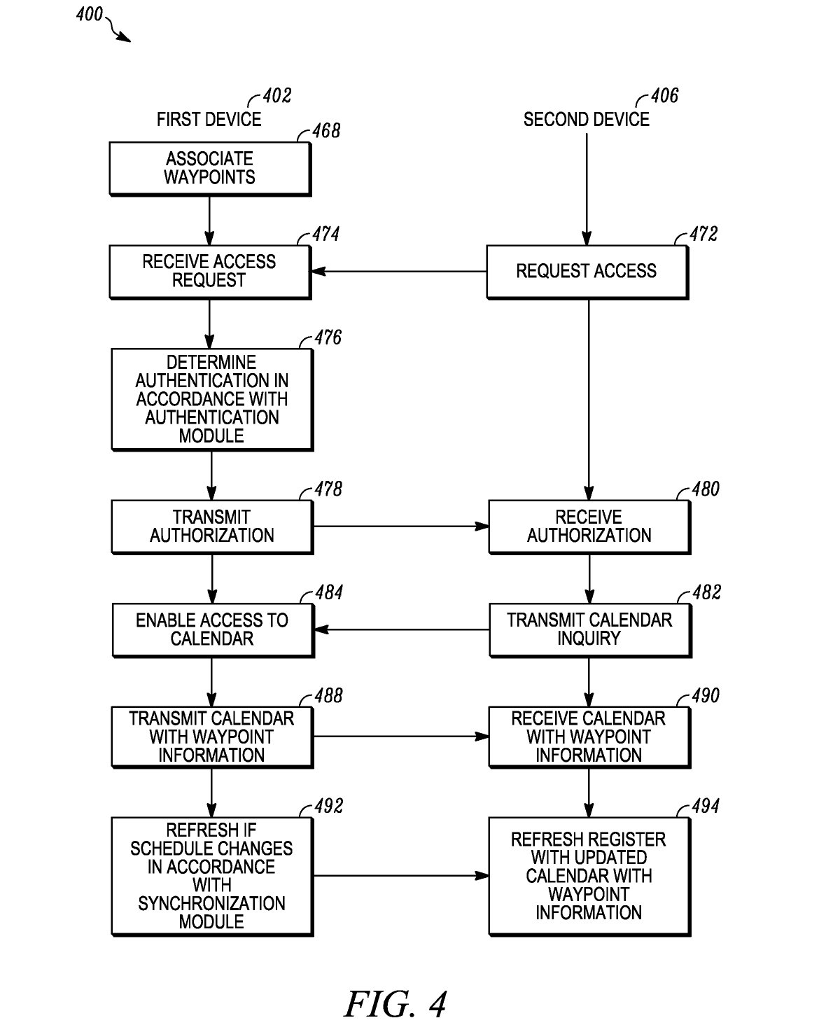

FIG. 4 is a signal flow diagram combined with a flowchart 400 to illustrate interaction in a system of a mobile communication device 402 and a second device 406 that may or may not be mobile. As discussed above, the first device 402 may associate waypoint information 468 with an entry to form a waypoint calendar 242 (see FIG. 2). In one embodiment, the second device 406 may request access 472 to a calendar entry 249 and its associated waypoint information, for example, to schedule one or more delivery attempts to the coordinates indicated in accordance with a waypoint. In one embodiment, the request for waypoint information may be selected from a group consisting of a Short Messaging Service message and an Unstructured Supplementary Service Data message. In another embodiment, the request for waypoint information may be in the form of a security message requesting permission to access secured waypoint information and time data from the calendar. The request and/or the access may conform to predetermined security criteria. The first device 402 may receive the access request 474. In accordance with an access enablement module 134 (see FIG. 1) that may be configured to allow or deny access by a second communication device 406 to at least one stored calendar entry the received request 474 may be analyzed by the first device for authentication 476. The analysis by the first device 402 may be in accordance with the access enablement module 134 that may include instructions to authenticate a request 472 to allow access by a second communication device 406.

An authorization 478 by the first device 402 may be transmitted to the second device 406 so that the second device 406 can receive the authorization 480. The second device 406 may transmit a calendar inquiry 482 and the first device 402 may enable access to the calendar 484. It is understood that any process by which the first communication device 402 may enable sharing with the second communication device 406, the entry in the calendar with the waypoint information is within the scope of the embodiments herein described. It is also understood that the access may be limited to a single calendar entry or to more than a single calendar entry.

The second communication device 406 may retrieve waypoint information from the calendar to form retrieved recipient calendar data when the first device 402 transmits waypoint information 488. In one embodiment, the transmission by the first device 402 may be selected from a group consisting of a Short Messaging Service message and an Unstructured Supplementary Service Data message. It is understood that any manner in which the first device 402 and the second device 406 exchange the waypoint information 490 is within the scope of the embodiments herein described. Moreover, it is understood that information not necessarily pertinent to the entity seeking the shared waypoint information of course need not be shared, since a shared portion of the calendar may be accessible to the second communication device.

As mentioned above, the mobile user may have one or more changes in the calendar 224 (see FIG. 2). The user may update the calendar accordingly. If the calendar is refreshed, the process between the first device 402 and the second device 406 may include synchronizing the waypoint information 492 of the first communication device 402 with the data stored in a register 108 (see FIG. 1) of the second communication device 406 in accordance with a synchronization module 138. Synchronizing the register 494 may include updating the waypoint information for multiple delivery locations in accordance with the synchronization module 138 that may be configured to provide updated calendar entries to a second mobile communication device. The second device 406 may initiate synchronization to verify that waypoint information, for example by returning to the step of requesting access 472 to the calendar of the first device 402.

By allowing the above-described communication between the first device 402 and the second device 406, a delivery service or other type of entity may access the coordinate information without the necessity of a mobile user manually sending a message including coordinates to the delivery service. It is understood that the above-described communication may be transparent to the user of the first device 402, or the user may be made aware of it for example by a message on display screen 116 (see FIG. 1) or 216 (see FIG. 2) and/or may authorize the communication via a user input such as a keypad 118 (FIG. 1) or 218 (FIG. 2), for example on a one time basis, or more frequently or indefinitely. User preferences of the first device 402 may provide options to a user as to when and how to allow the second device 406 to access the waypoint information of the waypoint calendar 242 (see FIG. 2). If a delivery service were able to access coordinate information of a user in conjunction with the user's calendar or other type of organizer, it may be less difficult for a delivery service or other type of entity associated with the second device 406 to determine the whereabouts of a user that may be mobile. This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, and all equivalents thereof, when interpreted in accordance with the breadth to which they are fairly, legally and equitably entitled.

1. A method of an Assisted Global Positioning System (AGPS) enabled mobile first communication device having a memory with a calendar, the method comprising:
saving a waypoint in memory, the waypoint having coordinates ascertained according to an AGPS capability of the first communication device, to form waypoint information;
associating the waypoint information with an entry in the calendar in the memory; and
enabling sharing with a second communication device, the entry in the calendar with the waypoint information.

2. The method of claim 1, further comprising:
storing the waypoint information in a data field annexed to the calendar.

3. The method of claim 1, wherein the calendar includes a secured entry with associated waypoint information, the method further comprising:
enabling access to the secured entry by the second communication device upon receipt of an authenticated request from the second communication device for permission to access the secured entry.

4. The method of claim 1, further comprising:
associating second waypoint information with an entry in the calendar;
creating a schedule of waypoints including the second waypoint information.

5. The method of claim 1, further comprising:
storing a radius value with the waypoint information in the memory;
associating the radius value with the entry in the calendar; and
enabling sharing with the second communication device, the radius value.

6. A method of a first communication device, the method comprising:
sending to an AGPS enabled mobile second communication device a message to request waypoint information and time data from a calendar of the second communication device; and
retrieving waypoint information and time data from a shared portion of the calendar to form retrieved calendar data.

7. The method of claim 6, wherein the message to request waypoint information is selected from a group consisting of a Short Messaging Service message and an Unstructured Supplementary Service Data message.

8. The method of claim 6, further comprising:
sending a security message to the second communication device to request permission to access secured waypoint information and time data from the calendar.

9. The method of claim 6, wherein retrieving includes retrieving secured waypoint information.

10. The method of claim 6, wherein the first communication device includes a location based server application and a register, the method further comprising:
sending to the second communication device a repeated request for waypoint information and time data from the calendar;
retrieving by the location based server application, waypoint information and time data from a shared portion of the calendar to form retrieved calendar data; and
refreshing the register with the retrieved calendar data.

11. A mobile communication device, comprising:
a controller configured to execute instructions of instruction modules;
a memory coupled to the controller, and configured to store instruction modules and to store calendar data including calendar entries;
an AGPS module configured to ascertain coordinates of a waypoint and configured to form waypoint information;
a calendar module configured to share stored calendar entries including stored waypoint information; and
an access enablement module configured to allow or deny access by a second communication device to at least one stored calendar entry.

12. The device of claim 11, wherein the calendar module includes instructions to create a schedule of user waypoints based on waypoint information.

13. The method of claim 11, wherein the calendar module includes instructions to store waypoint information in a data field annexed to a calendar entry.

14. The device of claim 11, wherein the access enablement module includes instructions to authenticate a request to allow access by a second communication device.

15. The device of claim 11, further comprising a waypoint data management module configured to associate a radius with particular waypoint information.

16. The device of claim 11, further comprising a synchronization module configured to provide updated calendar entries to a second mobile communication device.

17. A method of a system comprising an AGPS enabled mobile first communication device and a second communication device, the method comprising:
the first communication device saving a waypoint in memory, the waypoint having coordinates ascertained according to an AGPS capability of the first communication device, to form waypoint information;
the first communication device associating waypoint information with an entry in a calendar stored in memory of the first communication device; and
the first communication device enabling sharing with the second communication device, the entry in the calendar with the waypoint information.

18. The method of claim 17, further comprising:
the second communication device retrieving waypoint information from the calendar to form retrieved recipient calendar data.

19. The method of claim 17, the second communication device having a register including register data, the method further comprising:
synchronizing the waypoint information of the first communication device with the register data of the second communication device.

20. The method of claim 17, wherein the register includes a schedule for multiple delivery locations, the method further comprising:
synchronizing the register so as to update the schedule for multiple delivery locations.
